(19) United States
(12) Patent Application Publication
(10) Pub. No.: US 2008/0011330 A1
(43) Pub. Date: Jan. 17, 2008

(54) Apparatus And Method For Drying Disk-Shaped Substrates

(75) Inventor: Hans-Jurgen Kruwinus, Bodensdorf (AT)

Correspondence Address: YOUNG & THOMPSON, 745 SOUTH 23RD STREET, 2ND FLOOR, ARLINGTON, VA, 22202, US

(73) Assignee: SEZ AG, Villach (AT)

(21) Appl. No.: 11/791,953

(22) PCT Filed: Dec. 1, 2005
(86) PCT No.: PCT/EP05/56368

§ 371 Date: May 31, 2007

(30) Foreign Application Priority Data
Dec. 14, 2004 (AT) A 2097/2004

(51) Int. Cl. B08B 3/02

(52) U.S. Cl. 134/31; 134/176; 134/33; 134/34; 134/37

(57) ABSTRACT

A device for drying a disk-shaped substrate includes an element for holding a single disk-shaped substrate, an element for supplying rinsing liquid onto the disk-shaped substrate surface, an element for generating an aerosol and an element for supplying the aerosol onto the disk-shaped substrate surface. Also described is a method for drying a disk-shaped substrate including the steps of providing a single disk-shaped substrate, applying rinsing liquid to the disk-shaped substrate surface, applying an aerosol onto the disk-shaped substrate surface wherein the aerosol includes a drying liquid as disperse phase and an inert gas as the continuous phase. At least part of the liquid is present on the disk-shaped substrate during supply of the aerosol and aerosol droplets condense on liquid surface.

The invention relates to a device and a method for drying disk-shaped substrates comprising means for holding a single disk-shaped substrate. Such holding means for holding a single disk-shaped article can be a spin chuck as disclosed in U.S. Pat. No. 4,903,717. With such a device means for holding a single disk-shaped the disk-shaped article (e.g. semiconductor wafer, CD, flat panel display, hard disk, glass substrates) is typically not immersed into a liquid but rather is a liquid dispensed onto the surface of such disk-shaped article.

U.S. Pat. No. 5,271,774 discloses a method for drying disk-shaped substrates, which is a combination of supplying a vapour to the substrate and rotating the substrate simultaneously. The vapour is selected so that when mixed with a liquid yielding in a mixture having a surface tension, which is lower than that of the liquid as such. This shall help to apply the so called Marangoni effect to a spin dryer.

U.S. Pat. No. 5,882,433 discloses a spin drying method wherein the rinsing liquid is displaced either by a displacing liquid (e.g. 2-propanol) or a vapour thereof.

Both aforementioned embodiments of spin drying have the disadvantage that the amount of replacing liquid can hardly be controlled. If liquid is used the amount of liquid used is much too high especially with respect to cost of replacing liquid, fire hazardousness and environmental questions. If vapour is used the amount is possibly too low to achieve sufficient Marangoni effect. To increase vapour concentration it would have been possible to increase temperature in order to increase vapour pressure however this leads to another problem of fire hazardousness.

The invention meets the aforementioned objectives by providing a device for drying a disk-shaped substrate comprising
means for holding a single disk-shaped substrate
means for supplying rinsing liquid onto the disk-shaped substrate surface
means for generating an aerosol being connected to a drying liquid source for feeding drying liquid to the aerosol generator and
means for supplying said aerosol onto the disk-shaped substrate surface.

The term aerosol shall mean a gas liquid mixture wherein the disperse phase is liquid and the continuous phase is gas. The average droplet diameter is typically below 10 μm. Other terms used for aerosol are mist and fog.

Means for supplying rinsing liquid onto the disk-shaped substrate surface can be spray nozzles or a nozzle dispensing a free beam of liquid.

Such aerosol generator can be misleadingly called vaporizer or atomizer although they neither turn liquid into vapour nor into atoms. Better terms are nebulizer, mist generator or fog generator.

Means for supplying said aerosol onto the disk-shaped substrate surface for instance can be a showerhead or one or a plurality of dispense-nozzles. Such means for supplying aerosol can be fixedly mounted to the device or movably mounted e.g. on a dispense arm.

Advantageously no means (such as a rinsing bath) are provided to submerge the disk-shaped article.

The device advantageously further comprises means for rotatable holding the single disk-shaped substrate, which enhances drying efficiency because rinsing liquid is not only displaced by the drying liquid but also flung off by centrifugal force.

In a another embodiment means for generating the aerosol comprises means selected from a group comprising vibrating elements, high pressure liquid nozzle (called gasless or airless), air brush nozzle (connected to a gas source for delivering carrier gas), two fluid jet nozzle.

In a preferred embodiment the means for generating the aerosol comprise vibrating elements. Vibrating elements are typically sonic or ultrasonic means such as ultrasonic transducers. A source of drying liquid is connected to the vibrating elements or element. The selected drying liquid is fed to the vibrating element in small stream of liquid. By adjusting liquid volume flow, ultrasonic frequency and amplitude and gas volume flow the concentration of liquid in aerosol and droplet diameter can be controlled in order to achieve best drying efficiency.

In another embodiment the means for rotatable holding a single disk-shaped substrate further comprise a plate parallel to said disk-shaped substrate when being treated in order to provide a gap between the disk-shaped substrate and said plate. During rinsing and drying the disk-shaped substrate rinsing liquid is introduced into the gap and thereafter easily replaced by the aerosol.

Advantageously means for supplying said aerosol comprise at least one aerosol nozzle. Preferably said means for supplying said aerosol further comprises means for moving at least one aerosol nozzle across the surface of the disk-shaped substrate. E.g. the at least one aerosol nozzle can be mounted on a swivel arm. This enables that the aerosol nozzle can be scanned across the disk-shaped article in order to reach every region of the surface.

The means for applying said rinsing liquid may comprise a rinsing nozzle. Furthermore the device may comprise means for moving said rinsing nozzle across the surface of the disk-shaped substrate.

For drying under a specific atmosphere (e.g. inert gas) the device may further comprise a cover, which corresponds to the size of the disk-shaped substrate in order to cover said disk-shaped substrate.

In another embodiment the device further comprises a droplet separator, which is operatively arranged between the means for generating an aerosol and the means for supplying said aerosol. An advantage of using a droplet separator is described as follows. Impurities (e.g. particles) in the drying liquid typically lead to the formation of bigger droplets. Small droplets tend to condense on particles, which leads to the formation of bigger droplets surrounding such particles. Therefore separating of droplets brings the advantage of separating impurities from the aerosol.

Another aspect of the invention is a method for drying a disk-shaped substrate comprising the steps of
providing a single disk-shaped substrate
applying rinsing liquid to the disk-shaped substrate surface
applying an aerosol onto the disk-shaped substrate surface wherein the aerosol comprises a drying liquid as disperse phase and an inert gas as the continuous phase

wherein at least part of the liquid is present on the disk-shaped substrate during supply of the aerosol and aerosol droplets condense on liquid surface.

Typically water (preferably de-ionized water) is used as rinsing liquid.

For generating the aerosol preferably a drying liquid is used, which, when mixed with the rinsing liquid, yields in a liquid with lower surface energy than the previous rinsing liquid. Such drying liquid can be an alcohol, e.g. ethanol or 2-propanol.

Applying drying liquid to the rinsing liquid, which shall be displaced, in the form of an aerosol rather than as a pure liquid or vapour helps to control the exact surface concentration on the rinsing liquid being on the substrate surface. The control of the exact surface concentration is advantageous to hold the optimum with respect to achieving Marangoni effect and minimizing environmental impact and fire hazardousness.

In a second embodiment of the method the disk-shaped substrate is rotated about an axis substantially perpendicular to the disk-shaped substrate surface at least part of the time during aerosol is supplied to the disk-shaped substrate. This helps to enhance drying efficiency by spinning off the liquid.

In a third embodiment of the method the liquid and aerosol are at least part of the time supplied simultaneously.

In a fourth embodiment of the method the point of supply of the aerosol moves across the surface of the disk-shaped substrate.

In a fifth embodiment of the method the point of supply of the rinsing liquid moves across the surface of the disk-shaped substrate.

Furthermore a method for drying a disk-shaped substrate is provided wherein both sides of the disk-shaped are treated by one of the above-mentioned methods.

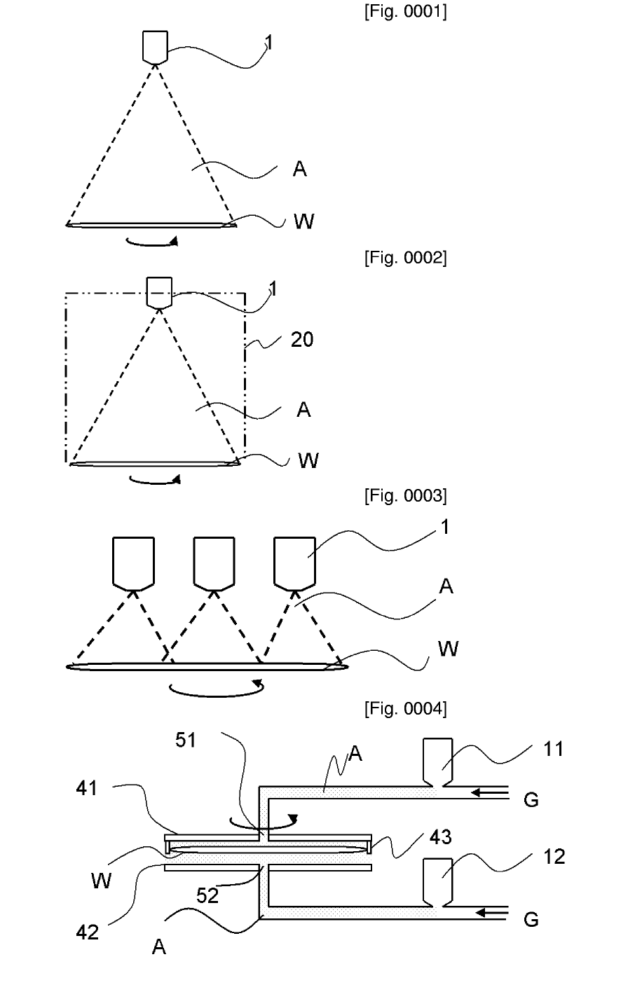

FIG. 1 shows a schematic view of an embodiment of the invention.

The wafer is provided in horizontal position. Aerosol A is supplied through aerosol nozzle 1, which is arranged centrally above the wafer. The shape of the aerosol nozzle and spraying conditions are selected in order to uniformly cover the wafer surface. Thus aerosol A will cover the full wafer W area wherein an aceotrop is formed and the water is removed by the aceotrop. Simultaneously due to the aerosol A droplets, which condense on water surface and dissolve in water, the contact angle (surface tension) will be lowered. Due to that fact a simultaneous spin-off will support the drying efficiency and watermarks will be avoided.

A semiconductor wafer W, which has been cleaned and rinsed, is dried with a method according to the invention.

Aerosol A is generated by a nozzle 1 and dispensed onto a wafer W surface. 90% of the droplets' volume lays in the range of a diameter of 1-200 μm.

In this example the aerosol nozzle 1 is placed static above the wafer W. Alternatively a showerhead, which supplies the aerosol A can be used.

The wafer is supported by a holder or chucking mechanism, which either is static or can rotate.

The aerosol A is made of 2-propanol (IPA). However, any other liquid, which is able to lower the surface tension of the previous rinsing liquid (e.g. DI-water) may be used.

The IPA volume flow is in a range between 0.1 ml/min to 100 ml/min depending on the substrate size. On less sensitive substrates volumes below 0.1 ml/min are also sufficient if the surface is strictly hydrophilic or hydrophobic. The volume flow shall be optimized in consideration of cleaning efficiency versus aerosol A consumption.

The apparatus shown in FIG. 2 is based on the apparatus shown in FIG. 1. However, the wafer W support is placed in a closed chamber with a housing 20. The nozzle 1 supplies the aerosol A into the chamber 3. Alternatively inert gas (e.g. N₂, He, Ar, Ne) can be supplied to the chamber 3 through an inert gas nozzle (not shown). Inert gas can also be supplied as a carrier gas for the aerosol through nozzle 1.

The apparatus shown in FIG. 3 is based on the apparatus shown in FIG. 1 and FIG. 2. However, a plurality of aerosol nozzles 1 are used.

The apparatus in FIG. 4 shows a wafer W, which is held between two parallel plates 41, 42. The wafer is tightly gripped by gripping pins 43, which are mounted to the upper plate 41. For releasing the wafer W these gripping pins 43 can be excentrically moved. For loading and unloading the wafer the upper plate 41 is lifted by a lifting mechanism (not shown).

In the gap between the top plate 41 and the wafer W as well as in the gap between the bottom plate 42 and the wafer W aerosol A is introduced through openings 51, 52 in the respective plate. The size of the upper gap is 1 mm; the size of the lower gap is 2 mm. The aerosol A is generated by injector nozzles 11, 12. Purging gas (e.g. inert gas) 3 is supplied to each injector nozzle 11, 12. The drying liquid (e.g. IPA) is fed to the injector nozzle 11, 12, where it is transformed into aerosol A. The aerosol introduced into the upper and lower gap displaces the previously applied rinsing fluid. Thereafter aerosol condenses on the wafer surfaces and plate surfaces. Remaining rinsing fluid residues dissolve in the condensed drying liquid. The mixture of rinsing fluid and drying liquid will be carried out by the carrier gas during and after the aerosol generator is operated. However, the apparatus can also be used for drying or treating one side of the wafer W. For displacing any drying liquid residues purging with inert gas is carried out as a subsequent step. Aerosol A and purging gas 3 are exhausted from the edge of the wafer W by an exhausting system (not shown).

The openings 51, 52, through which the aerosol is introduced, are shown as being centric with respect to the wafer W. Nevertheless, aerosol A can also be introduced over an edge portion of the wafer W. In this case aerosol A and purging gas 3 are sucked from the opposite edge portion.

FIG. 5 shows an apparatus based on the apparatus shown in FIG. 4. Each system for applying aerosol further comprises a droplet separator 21, 22. The droplet separator 21 (22) is inserted between aerosol generator 11 (12) and the aerosol dispense opening 51 (52). The droplet separator comprises a chamber with an aerosol entrance and an aerosol exit. Aerosol inserted into the chamber may carry to big droplets, which coagulate and/or condense on the chamber's walls or the liquid surface on the chamber's bottom. The so collected drying liquid exits through liquid exit 23 (24) and is either drained or recycled back to the aerosol generator 11 (12). Consequently the aerosol contains droplets of a smaller average size. Furthermore it is advantageous to heat the aerosol pipe leading to the aerosol dispense opening 51 (52). This helps to avoid condensing of the drying liquid in the aerosol pipe.

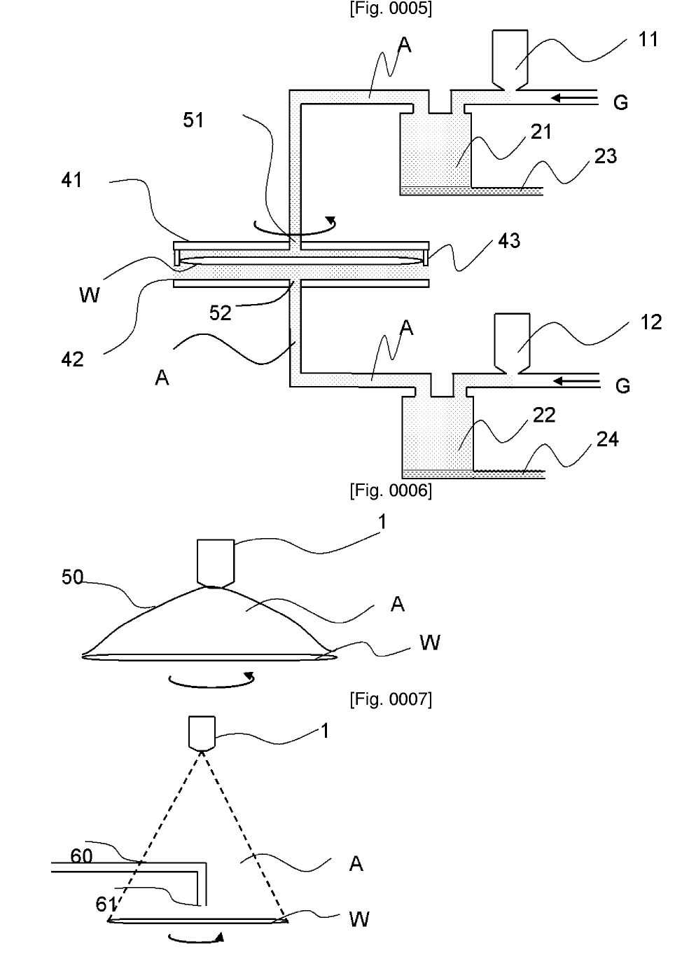

The apparatus shown in FIG. 6 is based on the apparatus shown in FIG. 1. Additionally a streaming-optimised cover 50 is mounted to the aerosol nozzle 1, which has the shape of a bell. Alternatively the cover 50 may have the shape of a showerhead. The diameter of the cover 50 corresponds to the respective wafer size. During processing the cover 50 is brought to close proximity to the wafer W by a lifting mechanism (not shown). The remaining gap between the cover 50 and the wafer edge shall be 2 mm. A chucking mechanism (not shown) holds the wafer W during the process. The chucking mechanism can rotate the wafer.

The aerosol nozzle 1 introduces the aerosol A into the space between the cover 50 and the wafer W.

Aerosol A is exhausted through the gap between the cover 50 and the wafer edge. Aerosol droplets condensing either on the wafer W or on the inner wall of the cover 50 can be spun off by spinning the wafer and/or carried out by purging gas.

The apparatus shown in FIG. 7 is based on the apparatus shown in FIG. 1. Additionally a dispense arm 60 with a dispense nozzle 61 for dispensing rinsing liquids is arranged above the wafer in order to dispense onto the same surface of the wafer W as the aerosol A is supplied to.

A chucking mechanism (not shown) holds the wafer W during the process. The chucking mechanism can rotate the wafer.

The dispense nozzle 61 may be static or moveably mounted above the wafer W. If moveably mounted, the dispense nozzle 61 may scan across the wafer surface in order to rinse each and every part of the wafer surface. When the wafer W is rotated the dispense nozzle 61 may move simply along a radius to reach each and every part of the wafer surface.

Advantageously dispensing of the rinsing liquid starts at the centre of the wafer W and moves towards the edge of the wafer W. In this case aerosol A condenses on the liquid surface of the dispensed liquid. The rinsing liquid/drying liquid boundary layer hereby slowly moves across the wafer W (from the centre to the edge). A preferred moving speed of the dispense nozzle 61 is 0.5 to 5 mm per second.

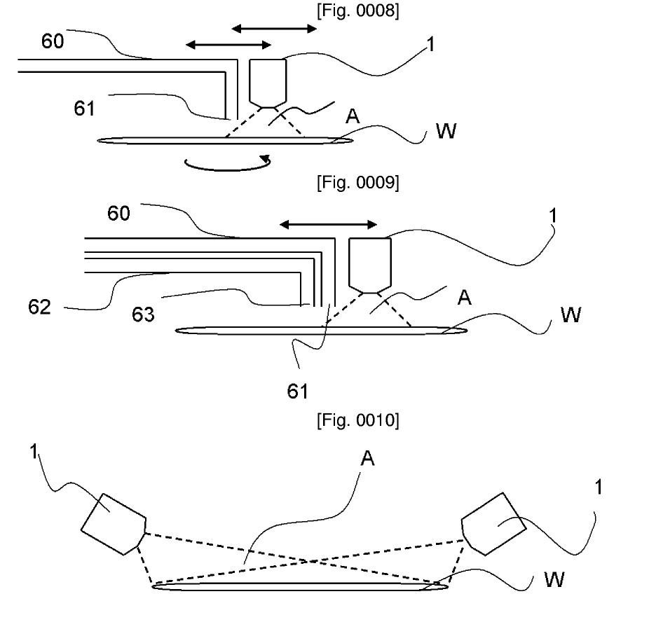

The apparatus shown in FIG. 8 is based on the apparatus shown in FIG. 7. However, the aerosol nozzle 1 is mounted on a separate arm (not shown). Therefore the aerosol nozzle 1 can be moved across the wafer W in close proximity to the wafer surface (e.g. 0.5 to 2 cm). Preferably the aerosol nozzle 1 follows the dispense nozzle 61 when it moves from the centre to the edge of the wafer W. When following the dispense nozzle 61 the distance between dispense nozzle and aerosol nozzle can be kept constant or can be changed. This shall be optimised with respect to the drying efficiency. If distance between aerosol nozzle and rinsing liquid dispense nozzle shall be constant the aerosol nozzle can be mounted on the same arm 60 as the dispense nozzle. Aerosol simultaneously condenses on the rinsing liquid surface as well as on the wafer surface. When scanning across the wafer rinsing liquid is directly displaced by drying liquid (deriving from the aerosol). Remaining rinsing liquid evaporates together with drying liquid from the wafer surface (e.g. as an aceotrop).

The apparatus shown in FIG. 9 is based on the apparatus shown in FIG. 8. However, a second dispense nozzle 63 is mounted on a second dispense arm 62. This embodiment of the invented method enables further optimization of the drying process especially at the edge of the wafer. It allows different motion speeds for the rinsing liquid supply arm and aerosol supply arm for drying.

FIG. 10 shows an alternate dispensing system for the aerosol comprising a plurality of aerosol nozzles 1. The space above the wafer W is thereby provided with aerosol A. Additionally the wafer W can be rinsed as shown in FIGS. 6, 7 and 8.

1. Device for drying a disk-shaped substrate comprising
means for holding a single disk-shaped substrate
means for supplying rinsing liquid onto the disk-shaped substrate surface
means for generating an aerosol being connected to a drying liquid source for feeding drying liquid to the aerosol generator and
means for supplying said aerosol onto the disk-shaped substrate surface.

2. Device according to claim 1 further comprising means for rotatable holding the single disk-shaped substrate.

3. Device according to claim 1 wherein the means for generating the aerosol comprises means selected from a group comprising vibrating elements, high pressure liquid spray nozzle (gasless), air brush nozzle (connected to a gas source for delivering carrier gas), two fluid jet nozzle.

4. Device according to claim 1 wherein the means for generating the aerosol comprise vibrating elements.

5. Device according to claim 2 wherein the means for rotatable holding a single disk-shaped substrate further comprise a plate parallel to said disk-shaped substrate when being treated in order to provide a gap between the disk-shaped substrate and said plate.

6. Device according to claim 1 wherein the means for supplying said aerosol comprise at least one aerosol nozzle.

7. Device according to claim 6 further comprising means for moving at least one aerosol nozzle across the surface of the disk-shaped substrate.

8. Device according to claim 1 wherein the means for applying said rinsing liquid comprise a rinsing nozzle.

9. Device according to claim 8 further comprising means for moving rinsing nozzle across the surface of the disk-shaped substrate.

10. Device according to claim 1 further comprising a cover, which corresponds to the size of the disk-shaped substrate in order to cover said disk-shaped substrate.

11. Device according to claim 1 further comprising a droplet separator, which is operatively arranged between the means for generating an aerosol and the means for supplying said aerosol.

12. Method for drying a disk-shaped substrate comprising the steps of
providing a single disk-shaped substrate
applying rinsing liquid to the disk-shaped substrate surface
applying an aerosol onto the disk-shaped substrate surface wherein the aerosol comprises a drying liquid as disperse phase and an inert gas as the continuous phase,
wherein at least part of the liquid is present on the disk-shaped substrate during supply of the aerosol and aerosol droplets condense on liquid surface.

13. Method according to claim 12 wherein said disk-shaped substrate is rotated about an axis substantially perpendicular to the disk-shaped substrate surface at least part of the time during aerosol is supplied to the disk-shaped substrate.

14. Method according to claim 12 wherein the liquid and aerosol are at least part of the time supplied simultaneously.

15. Method according to claim 12 wherein the point of supply of the aerosol moves across the surface of the disk-shaped substrate.

16. Method according to claim 12 wherein the point of supply of the rinsing liquid moves across the surface of the disk-shaped substrate.

17. Method for drying a disk-shaped substrate wherein both sides of the disk-shaped are treated by a method according to claim 12.
